(19) United States
(12) Patent Application Publication
(10) Pub. No.: US 2003/0056058 A1
(43) Pub. Date: Mar. 20, 2003

(54) Logical volume data migration

(76) Inventor: Alistair Veitch, Mountain View, CA (US)

Correspondence Address: HEWLETT-PACKARD COMPANY, Intellectual Property Administration, P.O. Box 272400, Fort Collins, CO, 80527-2400, US

(21) Appl. No.: 09/954,104

(22) Filed: Sep. 17, 2001

(51) Int. Cl. G06F 12/00

(52) U.S. Cl. 711/112; 711/6

(57) ABSTRACT

A method of and apparatus for logical volume data migration. A plurality of logical volumes for storing data in a storage system is formed in accordance with a first arrangement. A second arrangement for the plurality of logical volumes is developed. A shadow volume is formed for at least one of the logical volumes in accordance with the second arrangement. Each shadow volume represents a possible arrangement of the corresponding data. The data is migrated to the second arrangement. Accordingly, data in a logical volume is physically rearranged without having to completely reconstruct the logical volume. The invention preferably provides for assessing the feasibility of the proposed layout for the data and allows a user to envision this layout. In addition, the invention provides enhanced, fine-grain, control over the transition to the new layout. The data may be rearranged to improve performance, such as through load-balancing, or to provide additional storage capacity.

### FIELD OF THE INVENTION

The present invention relates to data storage for computer systems. More particularly, the present invention relates to the field of data migration in a data storage system.

### BACKGROUND OF THE INVENTION

Conventional computer operating systems and software programs generally expect the storage space that each uses to be contiguous. This means that the addresses of the data storage locations are sequential. Under certain circumstances, such as where multiple file systems share storage devices, it may be necessary to partition the storage. Typically, the storage is partitioned such that each partition is dedicated to a particular file system or software program.

Over time, the storage requirements for a particular one of the file systems or software programs may exceed the size of its allotted partition. The affected partition, however, may be positioned between other partitions such that it cannot easily be expanded. Under these circumstances, available storage locations may be obtained from another area of the storage system such that the locations used for the file system or software program are no longer contiguous.

A logical volume manager (LVM) may be employed where physical storage locations for a file system or software program are non-contiguous. A conventional LVM is a software program that maps physical storage locations to a contiguous address space, referred to as a “logical volume.” The LVM acts as an intermediary between a software program that uses the storage, such as a database program, and the physical memory devices (i.e. a hard disk or disks). Accordingly, non-contiguous storage locations appear to be contiguous even when they are not. The LVM can expand or contract the logical volume, as needed, without having to physically rearrange the corresponding data stored in the memory devices.

It may be desired, however, to physically rearrange data stored in a logical volume. A conventional technique for rearranging an LVM is to map the logical volume to a second, redundant physical storage device that stores a complete copy of the data that is arranged as desired. Then, the unwanted version can be abandoned, leaving one copy of the data arranged as desired. Accordingly, once a logical volume is initialized, the LVM cannot rearrange the data without reconstructing a complete copy of the data. This technique has drawbacks in that it is clumsy; it does not provide for assessing the feasibility of a new layout; certain data accesses are difficult, if not impossible, to accomplish while rearranging the data; and sufficient storage is required to simultaneously store two copies of the data. Also, there is no ability to control the rate at which copying occurs in such conventional systems.

Therefore, what is needed is a technique for rearranging data stored in a logical volume that does not suffer from the aforementioned drawbacks. It is to these ends that the present invention is directed.

### SUMMARY OF THE INVENTION

The invention is a method of and apparatus for logical volume data migration. The invention provides for the physical rearrangement of data in a logical volume without having to completely reconstruct the logical volume. The invention preferably provides for assessing the feasibility of a proposed layout for the data and allows a user to envision this layout. In addition, the invention provides enhanced, fine-grain, control over the transition to the new layout. Accordingly, the data can be rearranged more easily than by conventional techniques. For example, the data may be rearranged to improve performance, such as through load-balancing or to provide additional storage capacity.

In accordance with an aspect of the invention, a method of and apparatus for logical volume data migration is provided. A plurality of logical volumes for storing data in a storage system is formed in accordance with a first arrangement. A second arrangement for the plurality of logical volumes is developed. A shadow volume is formed for at least one of the logical volumes in accordance with the second arrangement. Each shadow volume represents a possible arrangement of the corresponding data. The data is migrated to the second arrangement. The logical volumes are reconstructed in accordance with the second arrangement.

The second arrangement may provide additional space in the storage system for expansion of one or more of the logical volumes or may distribute data accesses among storage devices more evenly thereby increasing performance of the storage system. A plan for migrating the data to the second arrangement may be proposed while a system administrator may approve the plan prior to the data being migrated.

The storage system may be divided into a plurality of extents, where each extent is associated with one of the logical volumes and includes a plurality of data storage locations. When a change is required to be made to the first arrangement, the second arrangement may be developed. The second arrangement may change one or more associations between the extents and the logical volumes. A determination may be made as to whether the second arrangement is to be adopted before migrating the data to the second arrangement. Otherwise, the shadow volumes may be discarded

A processor operating in accordance with stored software may form the shadow volume. A system administrator may determine whether the second arrangement is to be adopted. A processor operating in accordance with stored software may determine whether the second arrangement is feasible.

In accordance with another aspect of the invention, a method of logical volume data migration is provided. A plurality of logical volumes is formed for storing data in a storage system in accordance with a first arrangement. A second arrangement for the plurality of logical volumes is developed. The data is migrated to the second arrangement without making a complete copy of any of the plurality of logical volumes. The logical volumes are reconstructed in accordance with the second arrangement.

### BRIEF DESCRIPTION OF THE DRAWINGS

FIG. 1 illustrates a block schematic diagram of a general-purpose computer system by which the present invention may be implemented;

FIG. 2 illustrates storage devices that may be included in the computer system of FIG. 1;

FIG. 3 illustrates the storage devices of FIG. 2 having stored therein multiple logical volumes;

FIG. 4 illustrates the storage devices of FIG. 3 in which a portion of one of the logical volumes has been migrated to another physical location;

FIG. 5 illustrates the storage devices after having migrated another portion of one of the logical volumes to a physical location left vacant in FIG. 4;

FIG. 6 illustrates a flow diagram of a process of logical volume shadowing for migrating data among the storage devices of FIG. 2 in accordance with the present invention;

FIG. 7 illustrates the storage devices of FIG. 2 having a shadow volume superimposed thereon;

FIG. 8 illustrates the storage devices of FIG. 2 after having migrated one of the logical volumes to a new layout to make room for an expansion of another logical volume; and

FIG. 9 illustrates the storage devices of FIG. 2 after having expanded one of the logical volumes.

### DETAILED DESCRIPTION OF A PREFERRED EMBODIMENT

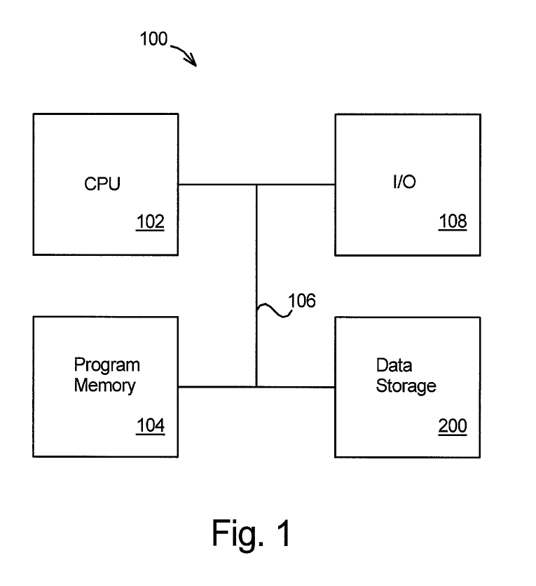

FIG. 1 illustrates a block schematic diagram of a general-purpose computer system 100 by which the present invention may be implemented. The computer system 100 may include a general-purpose processor 102, program memory 104 (e.g., RAM), data storage 200 (e.g., one or more hard disks), a communication bus 106, and input/output devices 108, such as a keyboard, monitor and mouse. The computer system 100 is conventional. As such, it will be apparent that the system 100 may include more or fewer elements than shown in FIG. 1 and that other elements may be substituted for those illustrated in FIG. 1.

One or more software programs for implementing the present invention may be stored in the memory 104. In a preferred embodiment, the present invention is implemented as a novel and improved logical volume manager (LVM) which may be implemented by the system 100.

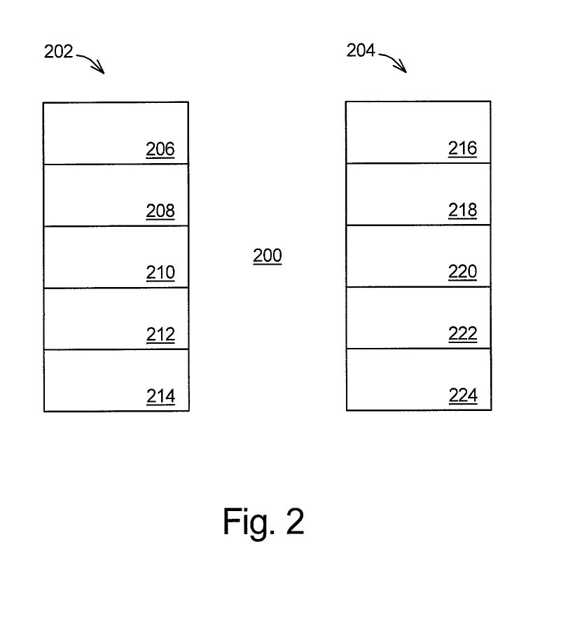

FIG. 2 illustrates storage devices 202 and 204 (also referred to as “logical units”—LUs) that may be included in the data storage 200 of FIG. 1. As such, the computer system 100 may also be referred to as a storage system. For example, the storage devices 202 and 204 may each include one or more hard disks of the memory 104 (FIG. 1). Alternately, the devices 202 and 204 may include another type of storage device. Further, rather than being included in the data storage 200, it will be apparent that the devices 202 and 204 may be a part of a data storage system that is coupled to the computer system 100, such as via a communication bus or network.

Each device 202 and 204 includes a number of divisions (also referred to as “extents”). Thus, device 202 includes divisions 206, 208, 210, 212, and 214, while device 204 includes divisions 216, 218, 220, 222 and 224. Each division includes a number of physical locations for data storage. For example, the divisions 206-224 may each include four megabytes (4 MB) of data storage space. While two devices 202 and 204, each having five divisions, are illustrated in FIG. 2, it will be apparent that a different number of devices may be provided and that each device may include more or fewer divisions. Further, it will be apparent that the divisions may be of any size and that the divisions need not all be the same size.

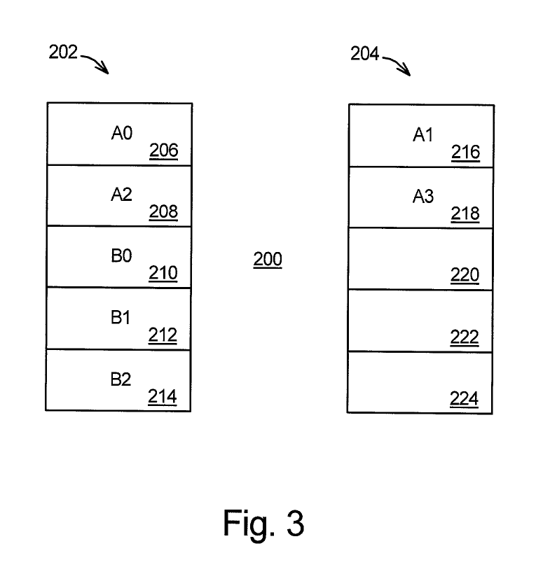

One or more logical volumes may be constructed among the devices 202 and 204. This may be performed, for example, by the system processor 102 of FIG. 1 under control of a system administrator. FIG. 3 illustrates an exemplary layout of logical volumes in which the storage devices 202 and 204 are illustrated as having stored therein two logical volumes. A first volume “A” may require four extents and may be striped across the devices 202 and 204 for performance reasons. Thus, a first portion A0 may be stored on extent 206 of device 202; a second portion A1 may be stored on extent 216 of device 204; a third portion A2 may be stored on extent 208 of device 202; and a fourth portion A3 may be stored on extent 218 of device 204. A second volume “B” may require three extents and may be allocated to the remaining extents of device 202. Thus, a first portion B0 may be stored on the extent 210; a second portion B1 may be stored on the extent 212; and a third portion B2 may be stored on the extent 214. While two logical volumes “A” and “B” are illustrated, it will be apparent that more or fewer logical volumes may be stored by the devices 202 and 204.

After the logical volumes (e.g., logical volumes A and B) have been set up, it may be desired to change their layout. For example, the amount of data required to be stored by one of the logical volumes may increase such that the logical volume requires additional extents. Alternately, the layout may be changed for other reasons, such as to increase performance. For example, it may be discovered that data accesses are concentrated to one storage device which results in degraded performance. Accordingly, rearranging the data such that the data accesses are more uniformly distributed among the storage devices may be desired so as to improve performance. Further, the layout may be changed to eliminate or reduce usage of faulty devices or devices that are to be replaced (e.g., devices that are planned to be made obsolete).

Conventionally, the only way to change the layout of existing logical volumes beyond merely adding to them would be to completely reconstruct them. However, in accordance with the present invention, this may be accomplished by migrating one or more portions of the existing logical volumes without having to tear down or reconstruct the logical volumes.

Assume, for example, that a system administrator decides that it would be preferable to stripe the portions B0, B1 and B2 of logical volume B across the devices 202 and 204. Thus, the portion B1 stored by extent 212 of device 202 may be migrated to the extent 220 of device 204. This may be accomplished by physically copying the portion B1 to the extent 220 and re-mapping the appropriate portion of the logical volume B to the storage locations of extent 220.

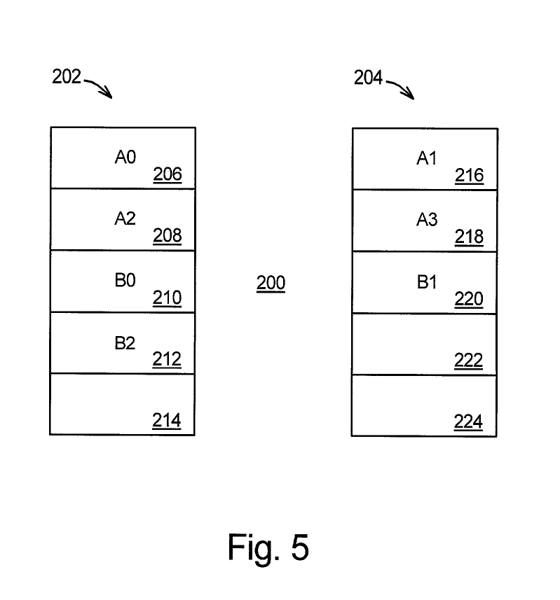

The portion B2 may then be moved from the extent 214 to the extent 212, which was vacated by portion B1. This may be desired, for example, to consolidate the free space available in the device 202 into contiguous storage locations. This migration may be accomplished similarly to the migration of portion B1, described above. That is, by physically copying the portion B2 to the extent 212 and re-mapping the appropriate portion of the logical volume B to the storage locations of extent 212. FIG. 5 illustrates the devices 202 and 204 after having migrated the portion B2 to extent 212.

Accordingly, a technique of a data migration for a logical volume has been described. The invention advantageously provides for the physical rearrangement of data in a logical volume without having to completely reconstruct the logical volume.

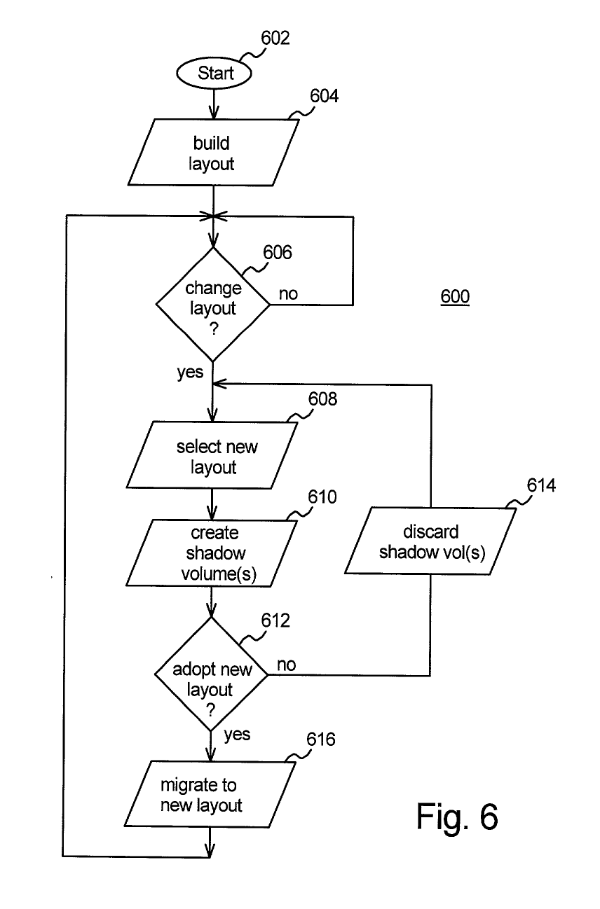

In accordance with another aspect of the invention, shadow volumes may be used to evaluate a proposed layout for one or more logical volumes before the data is physically migrated to the new layout. FIG. 6 illustrates a flow diagram 600 of a process of logical volume shadowing for migrating data among storage devices in accordance with the present invention. As mentioned, software which implements all or part of the process of FIG. 3 may be stored in the memory 104 of the computer system 100 of FIG. 1 for causing the processor 102 to perform steps of the process. It will be apparent, however, that one or more of the steps may be performed manually.

Referring to FIG. 6, program flow begins in a start state 602. From the state 602, program flow moves to a state 604 in which one or more logical volumes may be constructed. For example, the logical volumes may be constructed among the devices 202 and 204 of FIG. 2. This step may be performed, for example, by the system processor 102 of FIG. 1 under control of a system administrator. FIG. 3 illustrates an exemplary layout of logical volumes in which the storage devices 202 and 204 are illustrated as having stored therein two logical volumes.

Then, program flow moves from the state 604 to a state 606 in which a determination may be made as to whether the layout formed in the state 604 should be changed. For example, the amount of data required to be stored by one of the logical volumes may increase such that the logical volume requires additional extents. Alternately, the layout may be changed for other reasons, as explained above.

Assuming that the layout is to be changed, program flow moves from the state 606 to a state 608. Otherwise, program flow may remain in the state 606 until a change is needed.

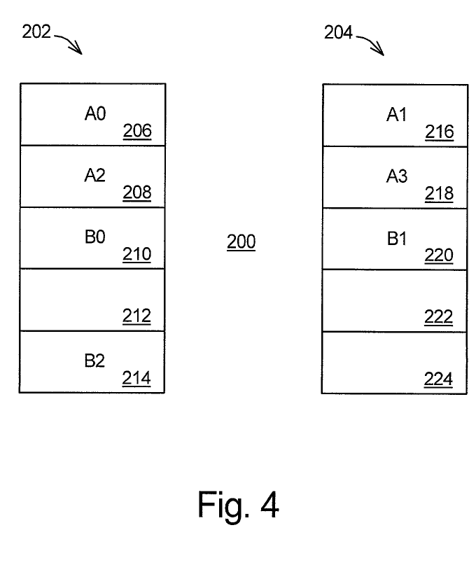

The layout for the logical volumes “A” and “B” of FIG. 4 may be rearranged in accordance with the present invention. As a particular example, the logical volume A may need to be expanded to include two additional extents. Conventionally, the only way to do this would be use available extents in device 204 (i.e. extents 220, 222 or 224). However, allocating the additional data to these extents would result in the data not being striped across the devices 202 and 204. Thus, in accordance with the invention, logical volume B is rearranged in order to make additional space available for logical volume A.

In the state 608, a proposed new layout for the logical volumes may be developed and selected based on the storage requirements of the logical volumes to be stored by the devices 202 and 204. For example, a system administrator may specify the proposed layout through a graphical user interface (GUI) provided by the system 100 of FIG. 1. Alternately, a software program stored in the memory 104 may be employed to develop one or more proposed layouts. The system administrator may then select from among the proposed layouts.

From the state 608, program flow moves to a state 610, in which one or more “shadow” volumes may be instantiated in accordance with the new layout. A shadow volume is a representation of a possible layout of an existing logical volume. In other words, the shadow volume indicates how the data might be stored by the storage devices. The shadow volume may include, for example, representations of the location(s) and space requirements within the storage system for the data underlying the logical volume and a map that correlates logical addresses to physical storage locations within the data storage system. Unlike a mirror copy in which two copies of the data are physically maintained and, thus, can be read from and written to, a shadow volume does not actually contain the underlying data. As such, the shadow volume cannot generally be read from or written to and can encompass extents that are currently storing other data.

The system processor 102 may instantiate the shadow volumes in response to the selections made by the system administrator in the state 306. Accordingly, the representation of the possible layout for the data may be stored in the memory 104 in the state 610 without actually changing the layout of the logical volumes.

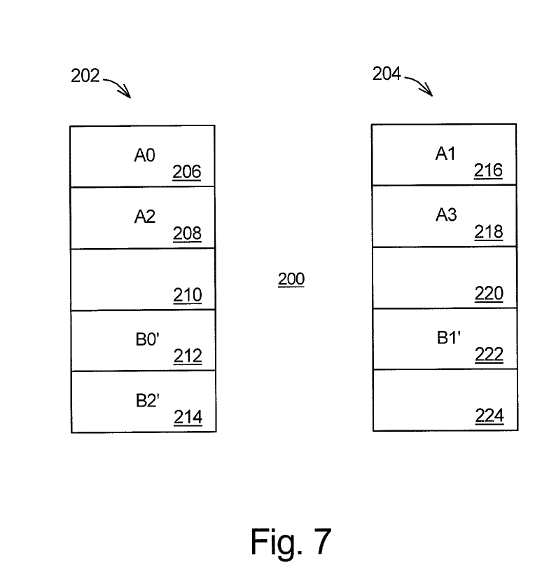

FIG. 7 illustrates the storage devices 202 and 204 having a shadow volume B′ superimposed thereon. The logical volume B is not shown in FIG. 7, however, it will be understood that it is unchanged, while shadow volume B′ is instantiated over the devices 202 and 204. Shadow volume B′ includes portions B0′, B1′ and B2′ that correspond to the portions B0, B1 and B2, respectively, of logical volume B. To make room available on device 202 for expanding the logical volume A, portion B0′ is positioned at extent 212 of device 202, portion B 1′ is positioned at extent 222 of device 204 and portion B2′ is positioned at extent 214 of device 202.

Returning to FIG. 6, program flow moves from the state 610 to a state 612. In the state 612, a determination may be made as to whether the layout selected in the state 608 is to be adopted. For example, the system administrator may review the proposed layout, including the shadow volumes created in the state 610. Based on this review, the system administrator may decide whether the proposed layout is feasible and whether it will provide a satisfactory result. Alternately, software stored in the memory 104 of the system 100 (FIG. 1) may be employed to make, or assist in, this determination. As an example, a software simulation or analytical model of the devices 202 and 204 may be constructed to determine whether the proposed layout will deliver desired levels of performance. Further, returning to the exemplary layout of FIG. 7, the system 100 may determine automatically whether the arrangement of shadow volume B′ will provide sufficient room in device 202 for the additional storage space required for logical volume A.

Assuming that it is determined in the state 612 that the proposed layout is not to be adopted, program flow moves to a state 614. In the state 614, the shadow volume(s) instantiated in the state 610 may be discarded. This may be accomplished by deleting them from the system memory 104. Because the shadow volumes do not actually hold data, they may be deleted without the loss of any data. From the state 614, program flow returns to the state 608 in which a new layout may be selected.

Otherwise, assuming that in the state 612 it is determined that the proposed layout is to be adopted, program flow moves to a state 616. In the state 616, the data stored by the logical volumes may be migrated into the new layout. This may be accomplished by the system processor 102 controlling the data movement as indicated by the new layout. In addition, the system 100 may appropriately reconstruct the logical volumes, such as by re-mapping the logical addresses presented to applications running on the system 100 to the physical storage location to which the data has been moved.

In a preferred embodiment, the system administrator may control the data migration, such as via a user interface provided by the system 100. For example, the system 100 may present the system administrator with a plan for migrating the data as a series of movements of data stored by the extents. The system administrator may then approve or modify the plan. Alternately, the plan may be automatically approved by the system 100 in response to analysis of the plan by the system 100.

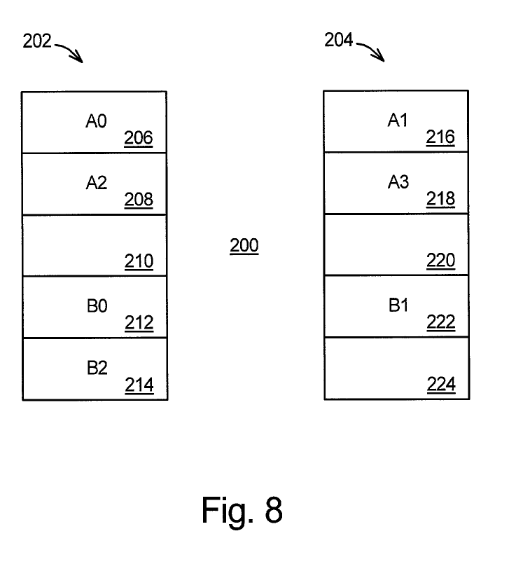

The number of moves required to achieve the desired layout will depend upon the circumstances. As a specific example referring to FIGS. 3 and 8, the plan may specify that the data stored by extent B1 is to be moved to extent 222. Then, the data stored by extent 210 may be moved to extent 222.

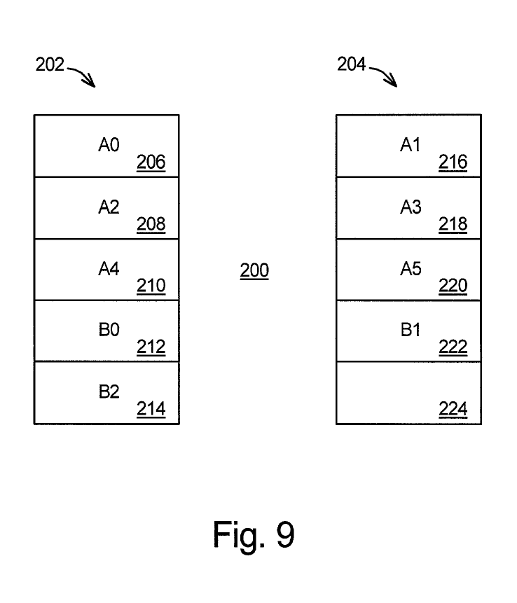

FIG. 8 illustrates the storage devices of FIG. 2 after the logical volume B has been migrated to the new layout indicated in FIG. 7. Thus, additional space is available for an expansion of the logical volume A. More particularly, extents 210 and 220 are available for expansion of logical volume A so as to maintain logical volume A striped across the devices 202 and 204. FIG. 9 illustrates the storage devices of FIG. 2 after having expanded the logical volume A.

From the state 616, program flow may return to the state 606. Program flow may remain in the state 616 until another change to the layout the logical volumes is required.

Accordingly, a technique of a logical volume shadowing for data migration has been described. The invention advantageously provides for the physical rearrangement of data in a logical volume without having to completely reconstruct the logical volume.

While the foregoing has been with reference to particular embodiments of the invention, it will be appreciated by those skilled in the art that changes in these embodiments may be made without departing from the principles and spirit of the invention, the scope of which is defined by the appended claims.

What is claimed is:

1. An apparatus for logical volume data migration comprising a storage system for storing a plurality of logical volumes, the logical volumes for storing data in accordance with a first arrangement; and a processor for forming a shadow volume for at least one of the logical volumes in accordance with a second arrangement for the plurality of logical volumes wherein each shadow volume represents a possible arrangement of the corresponding data and the processor for migrating the data to the second arrangement.

2. The apparatus according to claim 1, wherein the processor reconstructs the logical volumes in accordance with the second arrangement.

3. The apparatus according to claim 1, wherein a proposed layout for the second arrangement is approved prior to migrating the data.

4. The apparatus according to claim 1, wherein a proposed plan for migrating the data to the second arrangement is approved by a system administrator prior to migrating the data.

5. A method of logical volume data migration comprising:
a. forming a plurality of logical volumes for storing data in a storage system in accordance with a first arrangement;
b. developing a second arrangement for the plurality of logical volumes;
c. migrating the data to the second arrangement without making a complete copy of any of the plurality of logical volumes; and
d. reconstructing the logical volumes in accordance with the second arrangement.

6. The method according to claim 5, wherein the second arrangement provides additional space in the storage system for expansion of one or more of the logical volumes.

7. The method according to claim 5, wherein the second arrangement distributes data accesses among storage devices more evenly thereby increasing performance of the storage system.

8. The method according to claim 5, wherein the second arrangement reduces usage of a specified one of the storage devices.

9. The method according to claim 5, further comprising proposing a plan for migrating the data to the second arrangement and approving the plan by a system administrator prior to migrating the data.

10. A method of logical volume data migration comprising:
a. forming a plurality of logical volumes for storing data in a storage system in accordance with a first arrangement;
b. developing a second arrangement for the plurality of logical volumes;
c. forming a shadow volume for at least one of the logical volumes in accordance with the second arrangement wherein each shadow volume represents a possible arrangement of the corresponding data;
d. migrating the data to the second arrangement; and
e. reconstructing the logical volumes in accordance with the second arrangement.

11. The method according to claim 10, wherein the second arrangement provides additional space in the storage system for expansion of one or more of the logical volumes.

12. The method according to claim 10, wherein the second arrangement distributes data accesses among storage devices more evenly thereby increasing performance of the storage system.

13. The method according to claim 10, wherein the second arrangement reduces usage of a specified one of the storage devices.

14. The method according to claim 10, further comprising proposing a plan for migrating the data to the second arrangement and approving the plan by a system administrator prior to migrating the data.

15. The method according to claim 10, said forming the shadow volume being performed by a processor operating in accordance with stored software.

16. A method of logical volume data migration comprising:
a. forming a plurality of logical volumes for storing data in a storage system in accordance with a first arrangement, the storage system divided into a plurality of extents, each extent associated with one of the logical volumes and including a plurality of data storage locations;
b. when a change to the first arrangement is required, developing a second arrangement for the plurality of logical volumes wherein the second arrangement changes one or more associations between the extents and the logical volumes;
c. forming a shadow volume for at least one of the logical volumes in accordance with the second arrangement wherein each shadow volume represents a possible arrangement of the corresponding data; and
d. determining whether the second arrangement is to be adopted and when the second arrangement is to be adopted, migrating the data to the second arrangement and reconstructing the logical volumes in accordance with the second arrangement and, when the second arrangement is not to be adopted, discarding any shadow volumes.

17. The method according to claim 16, wherein the change to the first arrangement is to create additional space in the storage system for expansion of one or more of the logical volumes.

18. The method according to claim 16, wherein the change to the first arrangement is to increase performance of the storage system.

19. The method according to claim 16, wherein the second arrangement reduces usage of a specified portion of the storage system.

20. The method according to claim 16, further comprising proposing a plan for migrating the data to the second arrangement and approving the plan by a system administrator prior to migrating the data.

21. The method according to claim 16, said forming the shadow volume being performed by a processor operating in accordance with stored software.

22. The method according to claim 16, said determining whether the second arrangement is to be adopted being performed by a system administrator.

23. The method according to claim 16, wherein a processor operating in accordance with stored software determines whether the second arrangement is feasible.
